(19) United States
(12) Patent Application Publication
(10) Pub. No.: US 2025/0012960 A1
(43) Pub. Date: Jan. 9, 2025

(54) TAPERED ANTI-REFLECTION COATING THAT PRESERVES IMAGE SHARPNESS IN WAVEGUIDE COMBINERS

(71) Applicant: Applied Materials, Inc., Santa Clara, CA (US)

(72) Inventors: Kunal SHASTRI, Santa Clara, CA (US); Evan WANG, Palo Alto, CA (US); Simon LORENZO, Santa Clara, CA (US); David Alexander SELL, Santa Clara, CA (US); Kevin MESSER, Mountain View, CA (US); Samarth BHARGAVA, Saratoga, CA (US)

(21) Appl. No.: 18/746,195

(22) Filed: Jun. 18, 2024

Related U.S. Application Data
(60) Provisional application No. 63/512,112, filed on Jul. 6, 2023.

(51) Int. Cl. F21V 8/00; G02B 1/11

(52) U.S. Cl. CPC G02B 6/0016; G02B 1/11; G02B 6/0036; G02B 6/0046

(57) ABSTRACT

Embodiments of the disclosure provided herein include waveguide combiners. More specifically, embodiments described herein provide for waveguide combiners with a waveguide layer and a coating having a tapered portion disposed thereover. The waveguide includes one or more gratings, the one or more gratings including a plurality of grating structures disposed over a waveguide substrate, wherein the grating structures include a waveguide material, and the plurality of grating structures include exterior grating structures at outer edges of the one or more gratings. A waveguide layer is disposed over the waveguide substrate between the exterior grating structures and an edge of the waveguide substrate, the waveguide layer including the waveguide material, and a coating disposed over the waveguide layer, the coating having a tapered portion that is tapered from at least one of the exterior grating structures to a planar portion of the coating.

### CROSS-REFERENCE TO RELATED APPLICATION(S)

This application claims the benefit of and priority to U.S. Provisional Application 63/512,112 filed on Jul. 6, 2023, which is assigned to the assignee hereof and hereby expressly incorporated by reference herein in its entirety as if fully set forth below and for all applicable purposes.

### BACKGROUND

### Field

Embodiments of the present disclosure generally relate to waveguide combiners. More specifically, embodiments described herein provide for waveguide combiners with a waveguide layer and a coating having a tapered portion disposed thereover.

### Description of the Related Art

Virtual reality is generally considered to be a computer generated simulated environment in which a user has an apparent physical presence. A virtual reality experience can be three-dimensionally generated and viewed with a head-mounted display (HMD), such as glasses or other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhance or augment the environment that the user experiences. Image sharpness of the virtual image may be affected by the environment.

Accordingly, there is a need for waveguide combiners with a waveguide layer and a coating having a tapered portion disposed thereover.

### SUMMARY

Embodiments described herein generally relate to systems and methods used for waveguide combiners. More specifically, embodiments described herein provide for waveguide combiners with a waveguide layer and a coating having a tapered portion disposed thereover.

In an embodiment, a waveguide is provided. The waveguide includes one or more gratings, the one or more gratings including a plurality of grating structures disposed over a waveguide substrate, wherein the grating structures include a waveguide material, and the plurality of grating structures include exterior grating structures at outer edges of the one or more gratings. A waveguide layer is disposed over the waveguide substrate between the exterior grating structures and an edge of the waveguide substrate, the waveguide layer including the waveguide material, and a coating disposed over the waveguide layer, the coating having a tapered portion that is tapered from at least one of the exterior grating structures to a planar portion of the coating.

In another embodiment, a waveguide is provided. The waveguide includes one or more gratings including a plurality of grating structures disposed over a waveguide substrate, the plurality of grating structures including exterior grating structures at outer edges of the one or more gratings, a waveguide layer disposed over the waveguide substrate between the exterior grating structures and an edge of the waveguide substrate, and a coating disposed over the waveguide layer, the coating having a tapered portion that is tapered from at least one of the exterior grating structures to a planar portion of the coating adjacent to an outer taper edge of the tapered portion.

In yet another embodiment, a waveguide is provided. The waveguide includes one or more gratings including a plurality of grating structures disposed over a waveguide substrate. The plurality of grating structures include a waveguide material and exterior grating structures at outer edges of the one or more gratings. The waveguide also includes a waveguide layer disposed over the waveguide substrate between the exterior grating structures and an edge of the waveguide substrate, and a coating disposed over the waveguide layer, the coating having a tapered portion that is tapered from at least one of the exterior grating structures to a planar portion of the coating. The waveguide layer includes the waveguide material and having the same thickness as the plurality of grating structures.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the present disclosure and are therefore not to be considered limiting of its scope, and may admit to other equally effective embodiments of the present disclosure.

FIG. 1A illustrates a schematic top view of a waveguide combiner, according to certain embodiments.

FIG. 1B illustrates a schematic cross-sectional view of a portion of the waveguide combiner of FIG. 1A, according to certain embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments herein are generally directed to waveguide combiners for augmented reality. More particularly, the present disclosure relates to systems and methods for waveguide combiners with a waveguide layer and a coating having a tapered portion disposed thereover.

Diffractive waveguide combiners use gratings on a transparent substrate to replicate and redirect a virtual image from a light source to the user's eye while allowing the user to see the surrounding environment. The waveguide combiners, however, use high-refractive index substrates or coatings that reflect part of the incoming light, resulting in low transmission and unwanted reflections. The present disclosure provides a waveguide combiner with a coating including a taper at the boundaries between the grating and waveguide regions. The taper in the coating reduces the phase tear at the boundary and minimizes the reflections from ambient light to improve the modulation transfer function (MTF).

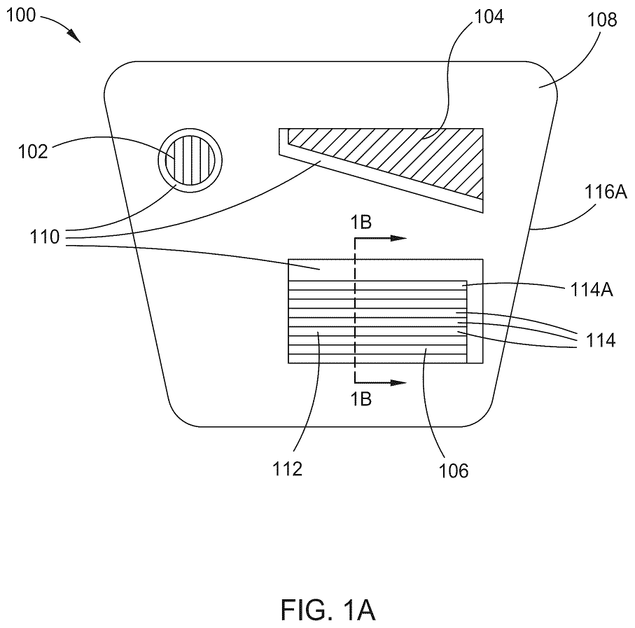

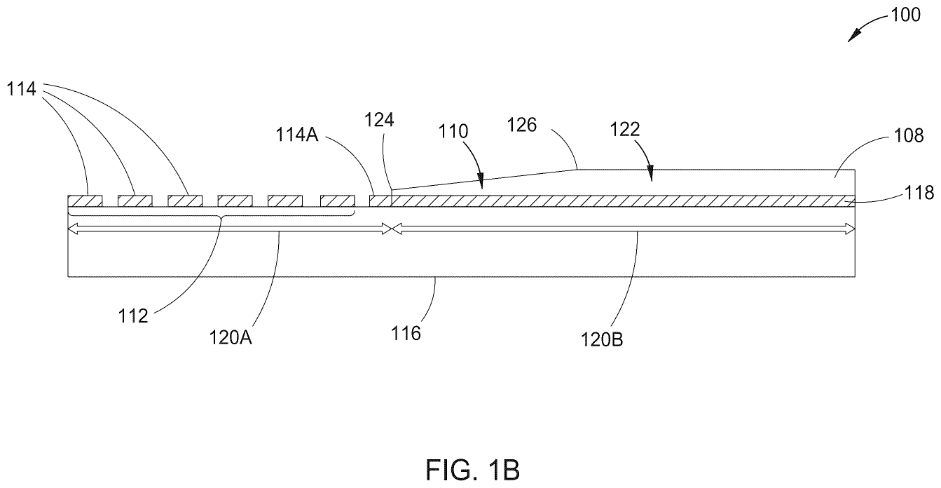

FIG. 1A is a schematic top view of a waveguide combiner 100. The waveguide combiner 100 includes one or more gratings 112. The one or more gratings 112 may include an input coupling grating 102, a pupil expansion grating 104, and an output coupling grating 106. A coating 108 is disposed over a waveguide substrate (not shown) between the one or more gratings 112. The one or more gratings 112 include grating structures 114 of a waveguide material. The waveguide material has a grating refractive index of about 2.0 to about 3.0. In some embodiments, the grating refractive index is about 2.2 to about 2.7. The waveguide material includes, but is not limited to, titanium oxide, niobium oxide, silicon nitride, silicon oxide, or combinations thereof. The coating 108 has a coating refractive index less than the grating refractive index such as between about 1.4 and about 1.8. The coating may be an anti-reflection coating. The anti-reflection coating includes, but is not limited to, silicon oxide, silicon nitride, or combinations thereof.

Further, each of the input coupling grating 102, the pupil expansion grating 104, and the output coupling grating 106 may include one or more gratings 112 disposed therein. The waveguide combiner 100 further includes at least one tapered portion 110 of the coating 108 on the input coupling grating 102, the pupil expansion grating 104, the output coupling grating 106, or a combination thereof as shown in FIG. 1A. Each of the at least one tapered portions 110 of the coating 108 begins with at least one of the exterior grating structures to a planar portion of the coating 102. The coating 108 has a taper portion 110 that is tapered from at least one of the exterior structures to a planar portion of the coating 102. The taper portion 110 may not completely surround the one or more gratings 112 and may only be disposed on certain sides or portions of the one or more gratings 112. When coating the waveguide region of a waveguide combiner with a coating that is anti-reflective, such as coating 102, the virtual image sharpness of the waveguide combiner suffers. When a pupil corresponding to a desired wavelength and the field of view is propagated using total internal reflection (TIR) at a sharp (e.g., non-tapered) coating boundary between the waveguide and the grating regions, such as at the edge of the coating 102 adjacent to one of the exterior grating structures 114A, the amplitude and phase of the two portions of the pupil that interact with the two different regions may be discontinuous, resulting in degradation of image sharpness. By including a taper, such as the tapered portions 110 on the coating 102, the amplitude and phase of the light propagation across the pupil improves the modulation transfer function and virtual image sharpness of the waveguide combiner. This results in increased transmission through the waveguide and reduced undesired reflections. Further, the tapered portions 110 include an angle and thickness that reduces wavefront aberrations in the pupil as it is guided into from the light engine to the user's eye.

The input coupling grating 102 receives incident beams of light (a virtual image) having an intensity from a microdisplay (not shown). The incident beams of light undergo total-internal-reflection (TIR) and propagate in the waveguide combiner 100 in order to direct the virtual image to the pupil expansion grating 104. The incident beams of light continue under TIR and propagate in the waveguide combiner 100 to direct the virtual image to the output coupling grating 106 where the incident beams of light are out-coupled to the user. As the incident beams of light propagate in TIR in the waveguide combiner 100, some of the beams of light will be incident on the input coupling grating 102, the pupil expansion grating 104, and the output coupling grating 106, while some of the beams of light will be incident on areas of the waveguide substrate adjacent thereto.

FIG. 1B illustrates a schematic cross-sectional side view of a portion of the waveguide combiner 100 of FIG. 1A. More specifically, FIG. 1B shows a cross-section of an output coupling grating 106, however, the components described herein may be components of the input coupling grating 102 or the pupil expansion grating 104 as well.

As shown in FIG. 1B, the waveguide combiner 100 includes a waveguide substrate 116 including a grating region 120A and a waveguide region 120B. The grating region 120A includes the one or more gratings 112 with a plurality of grating structures 114 disposed thereon. Each of the one or more gratings 112 includes exterior grating structures 114A disposed at the end of the grating 112.

The waveguide region 120A includes a waveguide layer 118 having the waveguide material and disposed over the 116. The waveguide layer 118 is disposed between the exterior grating structures 114A and the edge 116A of the waveguide substrate 116. A thickness of the waveguide layer 118 is the same as the plurality of grating structures 114. The coating 108 has a thickness of between about 10 nanometers (nm) to about 800 nm. The coating 108 is disposed over the waveguide layer 118 and has a tapered portion 110 from an outer taper edge 126 to an inner taper edge 124. As discussed above, the coating 108 is disposed adjacent to the one or more gratings 112 and the edge 116A of the waveguide substrate 116. The inner taper edge 124 is disposed adjacent to one of the exterior grating structures 114A. The outer taper edge 126 is at a boundary between a planar portion 122 of the coating 108. The planar portion 122 of the coating 108 is a portion of the coating 108 that has a substantially uniform thickness. The distance of the tapered portion 110, e.g., the distance between the outer taper edge 126 and the inner taper edge 124, is from about 1 micrometer (μm) to about 2000 μm. In some embodiments, the distance of the tapered portion 110 is from about 10 μm to about 1500 μm.

The present disclosure provides a tapered coating architecture on a waveguide combiner for head-mounted augmented reality applications. The coating is an anti-reflection coating that prevents light reflection at orthogonal angles within the waveguide substrate while facilitating light propagation for total internal reflection. The coating not only reduces unwanted reflections on the grating side, but also enhances the sharpness of the virtual image, greatly enhancing the user experience and reducing distractions.

While the foregoing is directed to embodiments of the present disclosure, other and further embodiments of the disclosure may be devised without departing from the basic scope thereof, and the scope thereof is determined by the claims that follow.

What is claimed is:

1. A waveguide, comprising:
one or more gratings, the one or more gratings comprising a plurality of grating structures disposed over a waveguide substrate, wherein:
the grating structures comprise a waveguide material, and
the plurality of grating structures comprise exterior grating structures at outer edges of the one or more gratings;
a waveguide layer disposed over the waveguide substrate between the exterior grating structures and an edge of the waveguide substrate, the waveguide layer including the waveguide material; and
a coating disposed over the waveguide layer, the coating having a tapered portion that is tapered from at least one of the exterior grating structures to a planar portion of the coating.

2. The waveguide of claim 1, wherein the coating is disposed over the waveguide substrate between the exterior grating structures and the edge of the waveguide substrate.

3. The waveguide of claim 1, wherein the one or more gratings are one of an input coupling region, an intermediate region, or an output coupling region.

4. The waveguide of claim 1, wherein the waveguide layer and the grating structures have the same thickness.

5. The waveguide of claim 1, wherein the coating has a refractive index of less than 2.0.

6. The waveguide of claim 1, wherein the coating comprises a coating refractive index and the waveguide layer comprises a waveguide layer refractive index, the coating refractive index is less than the waveguide layer refractive index.

7. The waveguide of claim 1, wherein of the coating includes a planar portion adjacent to an outer taper edge of the tapered portion.

8. A waveguide, comprising:
one or more gratings comprising a plurality of grating structures disposed over a waveguide substrate, the plurality of grating structures comprising a waveguide and comprising exterior grating structures at outer edges of the one or more gratings;
a waveguide layer having the waveguide material and disposed over the waveguide substrate between the exterior grating structures and an edge of the waveguide substrate; and
a coating disposed over the waveguide layer, the coating having a coating refractive index less than the waveguide layer refractive index and having a tapered portion that is tapered from at least one of the exterior grating structures to a planar portion of the coating adjacent to an outer taper edge of the tapered portion.

9. The waveguide of claim 8, wherein the one or more gratings are one of an input coupling region, an intermediate region, or an output coupling region.

10. The waveguide of claim 8, wherein the coating has a thickness of between about 10 nanometers to about 800 nanometers.

11. The waveguide of claim 8, wherein the coating refractive index is less than 2.0.

12. The waveguide of claim 8, wherein the waveguide layer and the grating structures have the same thickness.

13. The waveguide of claim 8, wherein a distance between the inner taper edge and an outer taper edge of the coating is from about 1 micrometer to about 2000 micrometers.

14. A waveguide, comprising:
one or more gratings comprising a plurality of grating structures disposed over a waveguide substrate, the plurality of grating structures comprise a waveguide material and exterior grating structures at outer edges of the one or more gratings;
a waveguide layer disposed over the waveguide substrate between the exterior grating structures and an edge of the waveguide substrate, the waveguide layer including the waveguide material and having the same thickness as the plurality of grating structures; and
a coating disposed over the waveguide layer, the coating having a tapered portion that is tapered from at least one of the exterior grating structures to a planar portion of the coating.

15. The waveguide of claim 14, wherein the one or more gratings are one of an input coupling region, an intermediate region, or an output coupling region.

16. The waveguide of claim 14, wherein the coating comprises a coating refractive index and the waveguide layer comprises a waveguide layer refractive index, the coating refractive index is less than the waveguide layer refractive index.

17. The waveguide of claim 16, wherein the coating refractive index is less than 2.0.

18. The waveguide of claim 14, wherein the coating has a thickness of between about 10 nanometers to about 800 nanometers.

19. The waveguide of claim 14, wherein the tapered portion comprises an outer taper edge adjacent to the planar portion of the coating and an inner taper edge adjacent to the exterior grating structures.

20. The waveguide of claim 20, wherein a distance between the inner taper edge and an outer taper edge of the coating is from about 1 micrometer to about 2000 micrometers.
